(19) United States
(12) Patent Application Publication
(10) Pub. No.: US 2010/0009679 A1
(43) Pub. Date: Jan. 14, 2010

(54) APPARATUS AND METHOD FOR SERVICE ACQUISITION IN A MULTIMODE SYSTEM

(75) Inventors: Noh-Sun KIM, Seoul (KR); Su-Yong YANG, Gunpo-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/465,152

(22) Filed: May 13, 2009

(30) Foreign Application Priority Data
Jul. 14, 2008 (KR) 10-2008-0068102

(51) Int. Cl. H04W 4/00

(52) U.S. Cl. 455/434; 455/435.2

(57) ABSTRACT

An apparatus and method for service acquisition in a multimode system are provided. The method includes attempting a first location registration to a mobile communication system having a highest priority according to a priority order and, attempting a next location registration to a mobile communication system of a next priority order from the priority order, if the first location registration is rejected for a specific cause.

### PRIORITY

This application claims the benefit under 35 U.S.C. § 119(a) of a Korean patent application filed in the Korean Intellectual Property Office on Jul. 14, 2008 and assigned Serial No. 10-2008-0068102, the entire disclosure of which is hereby incorporated by reference.

### BACKGROUND OF THE INVENTION

1. Field of the Invention

The present invention relates to an apparatus and method for registering a Mobile Station (MS). More particularly, the present invention relates to an apparatus and method for registration of an MS during a process in which a first registration to a communication system fails.

2. Description of the Related Art

In a mobile communication system, when an MS is powered on, it searches for surrounding cells and performs a location registration process to acquire service from a cell. In this case, the searched cells may support different communication systems that can be generally distinguished from each other by the MS.

For example, the MS may detect a cell that supports one of the MS′ communication systems from among cells that support diverse types of communication systems such as Wideband Code Division Multiple Access (WCDMA), Global System for Mobile communication (GSM), Wireless broadband (Wibro), CDMA 1× (Code Division Multiple Access 1×), etc. Once the cell is detected, the MS performs a location registration process for service with the detected cell.

FIG. 1 illustrates a conventional WCDMA system and a conventional GSM system.

Referring to FIG. 1, constructions of a WCDMA system 130 and a GSM system 120 are illustrated. A multimode MS 110, capable of communication with both the WCDMA system 130 and the GSM system 120, can be seamlessly provided with service, even when moving from one system to a different system, through a cell reselection process for WCDMA and GSM cells or a handover process while in a voice call, packet call, or idle status.

The multimode MS 110 searches for cells to acquire an initial service. In this case, the multimode MS 110 preferentially searches for cells having a higher priority order if there are two or more systems, and performs location registration with the higher priority cell.

Once found by the MS, the communication system allows or rejects the location registration depending on a network environment and a requesting MS. Also, the communication system temporarily rejects service or disables a request for service until the MS again powers off and on.

TABLE 1
Reject cause value (octet 2)

| Bits | |
|---|---|
| 87654321 | |
| 00000010 | IMSI unknown in HLR |
| 00000011 | Illegal MS |
| 00000100 | IMSI unknown in VLR |
| 00000101 | IMEI not accepted |
| 00000110 | Illegal ME |
| 00001011 | PLMN not allowed |
| 00001100 | Location Area not allowed |
| 00001101 | Roaming not allowed in this location area |
| 00001111 | No Suitable Cells In Location Area |
| 00010001 | Network failure |
| 00010100 | MAC failure |
| 00010101 | Synch failure |
| 00010110 | Congestion |
| 00010111 | GSM authentication unacceptable |
| 00100000 | Service option not supported |
| 00100001 | Requested service option not subscribed |
| 00100010 | Service option temporarily out of order |
| 00100110 | Call cannot be identified |
| 00110000 | |
| to | {close oversize brace} retry upon entry into a new cell |
| 00111111 | |
| 01011111 | Semantically incorrect message |
| 01100000 | Invalid mandatory information |
| 01100001 | Message type non-existent or not implemented |
| 01100010 | Message type not compatible with the protocol state |
| 01100011 | Information element non-existent or not implemented |
| 01100100 | Conditional IE error |
| 01100101 | Message not compatible with the protocol state |
| 01101111 | Protocol error, unspecified |

Any other value received by the mobile station shall be treated as 0010 0010, ‘Service option temporarily out of order’. Any other value received by the network shall be treated as 0110 1111, ‘Protocol error, unspecified’.
NOTE:
The listed reject cause values are defined in Annex G

Table 1 shows reasons a communication system may reject a request for service as described in the 3rd Generation Partnership Project (3GPP) Technical Specification (3GPP TS 24.008). According to the 3GPP specification, if a service request is rejected for any of causes #2, #3, or #6 (#2: International Mobile Subscriber Identity (IMSI) unknown in Home Location Register (HLR), #3: Illegal MS, and #6: Illegal Mobile Equipment (ME)), an MS remains in a service disabled status until the MS is again powered off and on or until a different (Universal) Subscriber Identity Module ((U)SIM) is installed. Thus, a normal service is not possible. An operation according to the rejection is commonly applied irrespective of a GSM system or a WCDMA system.

Accordingly, when a WCDMA or GSM system is selected according to a priority, if an MS is rejected for any of causes #2, #3, or #6 during location registration to the WCDMA or GSM system, the MS is in a service disabled status until re-installing a SIM, installing a new SIM, or powering off and on.

If a WCDMA system is considered having a high priority order, upon powering on, a multimode MS supporting both WCDMA and GSM systems preferentially attempts location registration to the WCDMA. Alternatively, a GSM-only MS attempts location registration to the GSM system.

In this case, there is a problem that, if being rejected from a WCDMA cell, the GSM-only MS normally operates, but the multimode MS remains in a service disabled status until again powering off and on.

### SUMMARY OF THE INVENTION

An aspect of the present invention is to address at least the above-mentioned problems and/or disadvantages and to provide at least the advantages below. Accordingly, an aspect of the present invention is to provide an apparatus and method for service acquisition in a multimode system.

Another aspect of the present invention is to provide an apparatus and method for acquiring service by distinguishing a communication system and attempting location registration in addition to a process for a reject cause when a Mobile Station (MS) is rejected by a communication system while performing a location registration procedure in a multimode system.

A further aspect of the present invention is to provide an apparatus and method for acquiring service by attempting location registration to a communication system of a next order when location registration is rejected from a communication system initially selected by a priority order.

The above aspects are addressed by providing an apparatus and method for service acquisition in a multimode system.

According to an aspect of the present invention, a location registration method of a Mobile Station (MS) in a mobile communication system is provided. The method includes attempting a first location registration to a mobile communication system having a highest priority according a priority order and, attempting a next location registration to a mobile communication system of a next priority from the priority order, if the location registration is rejected for a specific cause.

According to another aspect of the present invention, an apparatus of a Mobile Station (MS) for performing location registration in a mobile communication system is provided. The apparatus includes a communication module and a controller. The communication module communicates with a different node. The controller attempts location registration to a mobile communication system having a highest priority order through the communication module and, attempts a next location registration to a mobile communication system of a next priority order from the priority order, if the location registration is rejected for a specific cause.

Other aspects, advantages and salient features of the invention will become apparent to those skilled in the art from the following detailed description, which, taken in conjunction with the annexed drawings, discloses exemplary embodiments of the invention

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 illustrates a conventional Wideband Code Division Multiple Access (WCDMA) system and a conventional Global System for Mobile communication (GSM) system;

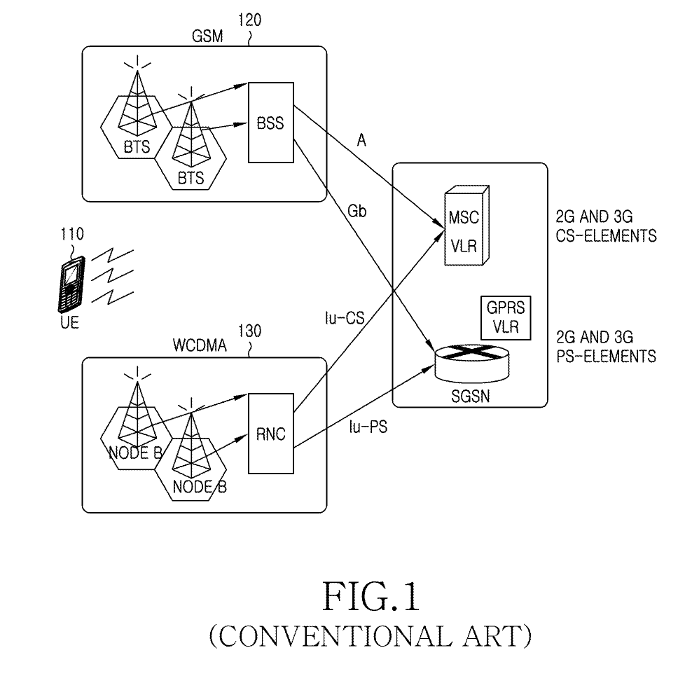

FIG. 2 is a flowchart illustrating a registration process of a Mobile Station (MS) according to an exemplary embodiment of the present invention;

FIG. 3 is a flowchart illustrating a first system conversion method upon a registration failure of an MS according to an exemplary embodiment of the present invention;

FIG. 4 is a flowchart illustrating a second system conversion method upon a registration failure of an MS according to an exemplary embodiment of the present invention; and

FIG. 5 is a block diagram illustrating a construction of an MS according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

An apparatus and method for service acquisition in a multimode system according to exemplary embodiments of the present invention are described below.

The exemplary embodiments of the present invention are applicable to a general wireless communication system capable of rejecting Mobile Station (MS) access. However, for purposes of illustration only, a dual mode MS supporting Wideband Code Division Multiple Access (WCDMA) and Global System for Mobile communication (GSM) is described. Hereinafter, an MS represents a dual mode MS.

For ease of description, exemplary embodiments of the present invention can be considered in three sections: a first section in which an MS determines if there is a communication system put in a priority order, depending on a response of a communication system; a second section of, if there is a communication system put in priority order, selecting a corresponding communication system; and a third section of attempting location registration for the selected communication system.

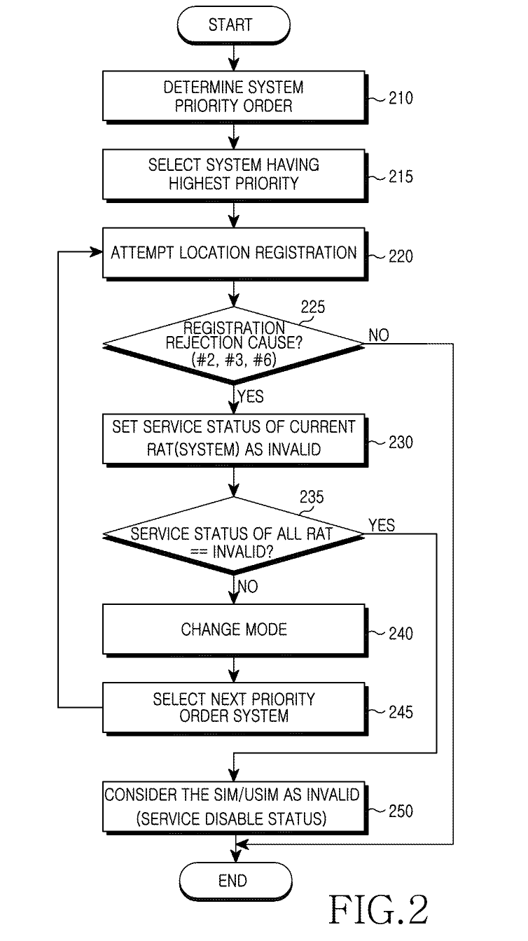

FIG. 2 is a flowchart illustrating a registration process of an MS according to an exemplary embodiment of the present invention.

Referring to FIG. 2, after powering on, an MS determines a priority order for communication systems supported by the MS in step 210, selects the communication system having the highest priority order in step 215, and attempts location registration with the selected communication system in step 220.

In step 225, it is determined if registration with the communication system having the highest priority order is rejected for any of the aforementioned #2, #3, or #6 causes. If it is determined that registration with the communication system is rejected for any of the aforementioned #2, #3, or #6 causes, the MS sets the service associated with the current Radio Access Technology (RAT) or communication system as invalid in step 230, and determines if all the communication systems supported by the MS are invalid in step 235.

If it is determined in step 235 that all the communication systems supported by the MS are invalid, the MS (e.g., a (Universal) Subscriber Identity Module ((U)SIM) of the MS) sets the current status of the MS as a disabled service status in step 250.

On the other hand, if it is determined that there is a communication system that has not been determined as invalid among the communication systems supported by the MS, in step 240 the MS changes its communication mode to correspond with the communication system that has not been determined as invalid and selects that communication system for location registration in step 245.

The MS returns to step 220 and attempts registration to the selected communication system that has not been determined as invalid from among the communication systems, and performs a subsequent process.

In another exemplary implementation, the process illustrated in FIG. 2 may also include a decision step following step 225. If it is determined that the registration has not been rejected for any cause, the MS finishes the illustrated process having successfully registered in step 220.

Then, the MS terminates the process of the exemplary embodiment of the present invention.

As illustrated above, if an MS is subjected to a registration rejection from a specific communication system that has the highest priority order, the MS attempts registration with another specific communication system that has the next highest priority order. In an exemplary embodiment as described below, the determining of the priority order may include a search for supportable communication systems and a sorting of the found systems.

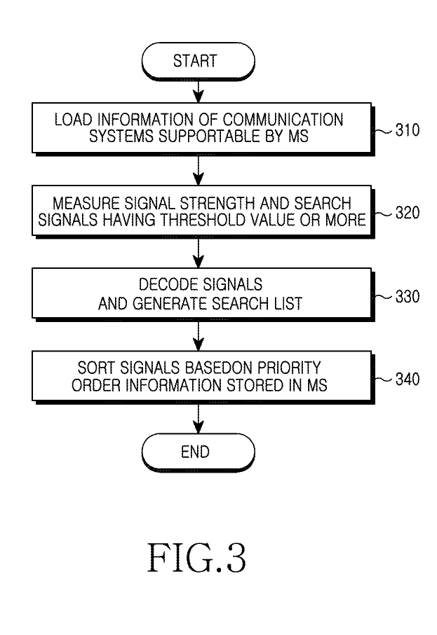

FIG. 3 is a flowchart illustrating a prioritizing method of an MS according to an exemplary embodiment of the present invention.

Referring to FIG. 3, the MS loads information regarding supportable communication systems in step 310.

In step 320, the MS searches for the supportable communication systems by determining if the respective strengths of signals received from the communication systems are greater than or equal to a threshold value. For the received signals that are greater than or equal to the threshold value, the MS attempts decoding of the signals in step 330 and sorts the searched communication systems in step 340. Then, the MS terminates the process.

As an example, an MS supporting a GSM communication system can, if decoding System Information 3 (SI3) of a searched signal, identify Mobile Country Code/Mobile Network Code (MCC/MNC) information and can identify a service provider using this information. As another example, an MS can identify a WCDMA communication system provider by decoding and using a Management Information Base (MIB).

In a communication system including a GSM system, a WCDMA system, etc., information regarding a service acquisition priority order based on MCC/MNC information, MIB information, etc. may be stored in a SIM or an MS (e.g. memory module) and thus, using this stored information, the MS can sort the communication systems based on the priority order, and can reduce the search time for subsequent additional service conversion, etc. by selecting a system of the highest priority order. That is, the MS sorts mobile communication systems transmitting respective signals having signal strengths greater than or equal to a threshold value according to a stored priority order and thus is capable of determining the priority order.

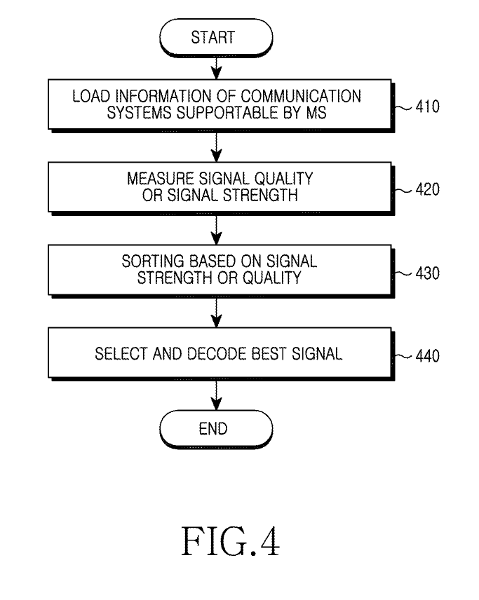

If using an exemplary method as described in FIG. 3, an MS decodes the entire searched signal and, therefore, a longer search time may be needed. An exemplary method for improving the search time is described in FIG. 4 below.

FIG. 4 is a flowchart illustrating a prioritizing method of an MS according to an exemplary embodiment of the present invention.

Referring to FIG. 4, the MS loads information of supportable communication systems in step 410. In step 420, the MS searches for the supportable communication systems by measuring a strength or quality of received signals. Based on the strength or quality of the received signals, the MS performs sorting in step 430. In step 440, the MS selects the best signal and attempts decoding of the corresponding signal.

Then, the MS terminates the process.

This exemplary method searches based on a strength or quality of a signal and performs decoding for the best signal. Therefore, a search time can be shortened and the power consumed by the MS can be reduced.

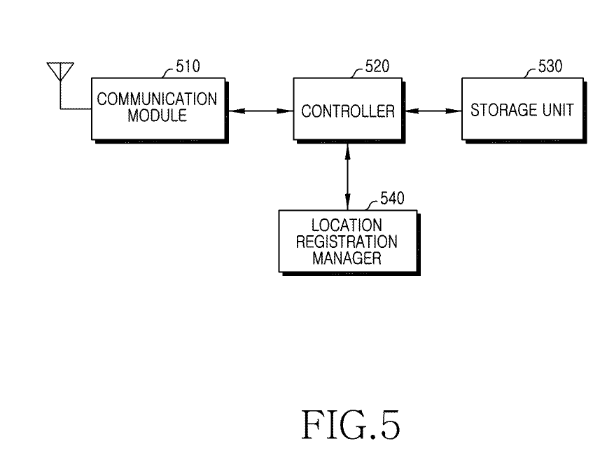

FIG. 5 is a block diagram illustrating a construction of an MS according to an exemplary embodiment of the present invention.

Referring to FIG. 5, the MS includes a communication module 510, a controller 520, a storage unit 530, and a location registration manager 540.

The communication module 510, which is a module for communicating with a different node, includes a wireless processor, a baseband processor, etc. The wireless processor changes a Radio Frequency (RF) signal received through an antenna into a baseband signal and provides the baseband signal to the baseband processor. The wireless processor also changes a baseband signal from the baseband processor into an RF wireless signal to enable transmission on a wireless path and transmits the wireless signal through the antenna.

The controller 520 controls a general operation of the MS. In particular, the controller 520 controls the location registration manager 540 according to an exemplary embodiment of the present invention.

The storage unit 530 performs a function of storing a program for controlling the general operation of the MS and of storing temporary data generated during program execution.

The location registration manager 540 determines a priority order for a communication system supported by the MS, selects a communication system of the highest priority order, and attempts location registration. If location registration is rejected because of the aforementioned #2, #3, or #6 causes, the location registration manager 540 determines a current communication system as invalid, and determines if all the communication systems supported by the MS are invalid. If all the communication systems supported by the MS are invalid, the location registration manager 540 determines a current status of the MS (specifically, the (U)SIM) as a disabled service status. If there is a communication system not determined as invalid among the communication systems supported by the MS, the location registration manager 540 changes a communication mode into the communication system not determined as invalid and selects the communication system not determined as invalid as the communication system intended for location registration.

The location registration manager 540 attempts registration to the communication system not determined as invalid among the communication systems. If registration is not rejected for the #2, #3, or #6 cause but is rejected for a different cause, the location registration manager 540 determines a current status of the MS (specifically, the (U)SIM) as a disabled service status.

The location registration manager 540 loads information regarding communication systems supportable by the MS. Then, the location registration manager 540 searches for each supportable communication system and, if a signal received from a supportable communication system has a strength or quality greater than or equal to a threshold value, attempts decoding of the signal. Based on the received and measured signals, the location registration manager 540 sorts the searched communication systems, and selects a priority communication system with reference to stored information.

Alternatively, the location registration manager 540 loads information regarding supportable communication systems, searches for signals by measuring signal strength or quality, performs sorting based the measure strength or quality, and selects the best signal. Then, the location registration manager 540 attempts decoding for a corresponding signal, and selects a communication system based on the corresponding signal.

In the aforementioned construction, the controller 520 and the location registration manager 540 are illustrated as separate modules. However, this is merely for convenience in order to distinguish and describe their respective functions and it is understood that the controller 520 may perform some or all of the functions of the location registration manager 540. Thus, when a product is actually realized, the product can be constructed so that the controller 520 can process all of the functions of the location registration manager 540. Alternatively, the product can be constructed so that the controller 520 can process only part of them.

In exemplary embodiments of the present invention, although a dual mode MS fails in registration to one communication system, the dual mode MS attempts registration to a different communication system and thus, there is an advantage of improving service acquisition possibility.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A location registration method of a Mobile Station (MS) in a mobile communication system, the method comprising:
attempting a first location registration to a mobile communication system having a highest priority according to a priority order; and
attempting a next location registration to a mobile communication system of a next priority from the priority order, if the first location registration is rejected for a specific cause.

2. The method of claim 1, further comprising, determining the priority order before the attempting of the first location registration to the mobile communication system having the highest priority order.

3. The method of claim 1, wherein the specific cause comprises at least one of an International Mobile Subscriber Identity (IMSI) unknown in a Home Location Register (HLR), an illegal MS, and an illegal Mobile Equipment (ME).

4. The method of claim 2, wherein the determining of the priority order comprises:
loading information regarding a mobile communication system supportable by the MS;
measuring the strength of a signal transmitted by the mobile communication system;
determining if the measured strength is greater than or equal to a threshold;
if the measured strength is greater than or equal to the threshold, decoding the signal of the mobile communication system; and
sorting the mobile communication system of the decoded signal according to the priority order.

5. The method of claim 4, further comprising, if the mobile communication system comprises a Global System for Mobile communication (GSM) communication system, acquiring the priority order from a Mobile Country Code/Mobile Network Code (MCC/MNC) acquired by decoding System Information 3 (SI3) of a searched signal.

6. The method of claim 4, further comprising, if the mobile communication system comprises a Wideband Code Division Multiple Access (WCDMA) communication system, acquiring the priority order from information decoding a Management Information Base (MIB).

7. The method of claim 2, wherein the determining of the priority order comprises:
loading information of a mobile communication system supportable by the MS;
measuring at least one of the strength and the quality of a signal transmitted by a mobile communication system;
sorting the signal according to the measured at least one of the strength and the quality of the signal;
decoding the signal having the highest of at least one of the strength and the quality; and
selecting a mobile communication system corresponding to the signal having the highest of at least one of the strength and the quality.

8. An apparatus of a Mobile Station (MS) for performing location registration in a mobile communication system, the apparatus comprising:
a communication module for communicating with a different node; and
a controller for attempting location registration to a mobile communication having a highest priority order through the communication module and, attempting a next location registration to a mobile communication system of a next priority order if the location registration is rejected for a specific cause.

9. The apparatus of claim 8, wherein, the controller determines the priority order before the attempting of the location registration to the mobile communication system of the highest priority order.

10. The apparatus of claim 8, wherein the specific cause comprises at least one of an International Mobile Subscriber Identity (IMSI) unknown in Home Location Register (HLR), an illegal MS, and an illegal Mobile Equipment (ME).

11. The apparatus of claim 9, wherein the controller loads information of a mobile communication system supportable by the MS, measures the strength of a signal transmitted by the mobile communication system, determines if the measured strength if greater than or equal to a threshold, if the measured strength is greater than or equal to the threshold, decodes the signal of the mobile communication system, sorts the mobile communication system of the decoded signal according to a priority order and determines the priority order.

12. The apparatus of claim 11, wherein, if the mobile communication system comprises a Global System for Mobile communication (GSM) communication system, the controller acquires the priority order from a Mobile Country Code/Mobile Network Code (MCC/MNC) acquired by decoding System Information 3 (SI3) of a searched signal.

13. The apparatus of claim 11, wherein, if the mobile communication system comprises a Wideband Code Division Multiple Access (WCDMA) communication system, the controller acquires the priority order from information decoding a Management Information Base (MIB).

14. The apparatus of claim 9, wherein the controller loads information of a mobile communication system supportable by the MS, measures at least one of strength and quality of a signal transmitted by a mobile communication system, sorts the signal according to the measured at least one of strength and quality of the signal, decodes the signal having the highest at least one of strength and quality, and selects a mobile communication system corresponding to the signal having the highest at least one of strength and quality.

15. A registration method for a Mobile Station (MS), the method comprising:
determining a priority of communication systems;
attempting a registration with the communication system having the highest priority among the communication systems;
determining if the registration with the communication system having the highest priority fails; and
attempting a next registration with the mobile communication system having the next highest priority among the communication systems if the registration with the communication system having the highest priority fails.

16. The method of claim 15, wherein the determining if the registration with the communication system having the highest priority fails comprises determining if the registration fails for at least one of an International Mobile Subscriber Identity (IMSI) is unknown in a Home Location Register (HLR), the MS is an illegal MS, and the MS is an illegal Mobile Equipment (ME).

17. The method of claim 16, further comprising:
setting a service status of the communication system having the highest priority as invalid if the registration fails;
determining if the service status of all found communication systems is invalid; and
setting the service status of the MS as disabled if the service status of all communication systems is invalid.

18. The method of claim 17, further comprising:
if the service status of all communication systems is not invalid, selecting the next highest priority system for registration prior to the attempting of the next registration.

19. The method of claim 15, wherein the determining of the priority of the communication systems comprises:
loading information regarding mobile communication systems supportable by the MS;
measuring the respective strengths of signals transmitted by the mobile communication systems supportable by the MS;
determining if the measured respective strengths are greater than or equal to a threshold;
if the respective measured strengths are greater than or equal to the threshold, decoding the signals of the mobile communication system; and
sorting the mobile communication systems corresponding to the decoded signals according to the priority order.

20. The method of claim 15, wherein the determining of the priority of the communication systems comprises:
loading information of mobile communication systems supportable by the MS;
measuring at least one of the strength and the quality of respective signals transmitted by the mobile communication systems supportable by the MS;
sorting the signals according to the measured at least one of the strength and the quality of the signal;
decoding the signal having the highest of the at least one of strength and quality; and
selecting a mobile communication system corresponding to the signal having the highest of the at least one of strength and quality.
